(19) United States
(12) Patent Application Publication
(10) Pub. No.: US 2016/0264752 A1
(43) Pub. Date: Sep. 15, 2016

(54) MATERIAL AND DEVICE FOR THE CONTAINMENT OF CRYOGENIC LIQUIDS

(71) Applicants: Airbus Defence and Space SAS, Les Mureaux (FR); Institut National des Sciences Appliquees, Villeurbanne Cedex (FR); Insavalor, Villeurbanne (FR)

(72) Inventors: Julien L'INTERMY, Villeurbanne (FR); Brigitte DEFOORT, Saint Medard en Jalles (FR); Jannick DUCHET-RUMEAU, Sainte Euphemie (FR); Jean-Francois GERARD, Bron (FR)

(21) Appl. No.: 15/031,408

(22) PCT Filed: Oct. 28, 2014
(86) PCT No.: PCT/EP2014/073142

§ 371 Date: Apr. 22, 2016

(30) Foreign Application Priority Data
Oct. 29, 2013 (FR) 1360537

(51) Int. Cl. C08K 3/04; F16J 12/00; C08K 5/20

(52) U.S. Cl. CPC C08K 3/04; C08K 5/20; F16J 12/00; F17C 2203/0675; F17C 2221/014; F17C 2221/012; F17C 2221/017; F17C 2221/033; F17C 2223/0161; F17C 2270/0197; F17C 2221/016

(57) ABSTRACT

A composite material for manufacturing a device for containment of a cryogenic liquid and a device for containment of a cryogenic liquid which comprises at least one layer made of this composite material. The composite material is obtained from a composition comprising, in percentages by weight relative to the total weight of the composition: from 60% to 90% of a polyamide chosen from polyamides 6, 6.6 and 6/6.6 and mixtures thereof; from 10% to 30% of a primary synthetic graphite in the form of particles; and from 0% to 10% of an anti-oxidant. Applications: manufacture of cryogenic tanks and notably liquid oxygen tanks, particularly for a space launcher, manufacture of supply lines of cryogenic liquids and particularly liquid oxygen; manufacture of any device for the storage, transport and/or supply of a gas under pressure.

### TECHNICAL FIELD

The invention relates to the field of containment of cryogenic liquids, i.e. liquefied gases that are kept and/or used at temperatures between −150° C. and absolute zero degree (−273.15° C.). Typically this refers to nitrogen, helium, neon, argon, krypton, hydrogen, methane, oxygen and natural gas.

More specifically, the invention relates to the use of a particular composite material for manufacturing a device for containment of a cryogenic liquid.

It also relates to a device for containment of a cryogenic liquid that comprises at least one layer made of this composite material.

The invention is useful in applications for manufacturing cryogenic tanks and notably liquid oxygen tanks, particularly for a space launcher.

However, it may also be used in applications for manufacturing supply lines of cryogenic liquids and particularly liquid oxygen, as well as for manufacturing any device for the storage, transport and/or supply of a gas under pressure.

### STATE OF PRIOR ART

Cryogenic tanks and particularly oxygen tanks used in space launchers are traditionally made of metal alloys.

Metal alloys used to make these tanks have a number of disadvantages, particularly including high density (which constitutes therefore a limit to the reduction of the weight of space launchers), not very good commercial availability (long procurement times and small choice of references), and high costs, especially since material losses by machining may be high (up to 80%).

The use of composite materials should make it possible to overcome these disadvantages in that composite materials are usually less dense, less expensive and easier to work than metal alloys.

Globally, two strategies are envisaged in the design of cryogenic tanks from composite materials. The first strategy is to make these tanks by superposing several layers of different materials including an internal layer called <<liner>>, which has the essential function of maintaining leak tightness to the cryogenic liquid, an intermediate layer with the essential function of being structural (in other words, in practice, mechanical strength), and an external layer that essentially acts as thermal insulation. The second strategy consists of making liner-free tanks, in which case the wall thickness of these tanks must be such that the tank can perform structural and leak tightness functions.

When the cryogenic tank is a liquid oxygen tank, it is essential that the material forming the part of the reservoir that will be in contact with liquid oxygen is compatible with the liquid oxygen. This compatibility means that even if energy is added, there is no risk that the material will generate a violent reaction, despite the highly oxidising nature of oxygen. Compatibility of a material with liquid oxygen, which is more simply referred to as <<LOX compatibility>>, is determined by standard tests, and in particular tests according to standard ASTM D2512 (<<Standard Test Method for Compatibility of Materials with Liquid Oxygen (Impact Sensitivity Threshold and Pass-Fail Techniques)>>).

It is well known that polymers generally tend to react in an oxidising environment with the addition of an energy source.

It has been suggested that a thermoplastic fluoropolymer could be used to line liquid oxygen tanks, specifically a poly(ethylene-tetrafluoroethylene) or ETFE (Kooij et al., Proceedings of the European Conference on Spacecraft Structures, Materials and Mechanical Testing, Nov. 29-Dec. 1, 2000, Noordwijk, Netherlands, pp. 187-192, reference [1]; Baker et al., International Conference on Green Propellant for Space Propulsion, June 2001, Noordwijk, Netherlands, pp. 327-334, reference [2]). Unfortunately, this fluoropolymer is permeable to oxygen and to helium so that it is not suitable for making a liner for liquid oxygen tanks which, by definition, must be leak tight to liquid oxygen and only very slightly permeable to helium used as the pressurisation gas. Furthermore, there are some health and safety (H&S) risks with this use.

The use of composite materials made of an epoxy or polyurethane matrix reinforced by montmorillonite or hydrotalcite type nanofillers has also been suggested (Scatteia et al., Proceedings of the 54th International Astronautical Congress of the International Astronautical Federation, October 2003, Bremen, Germany, pp. 1630-1642, reference [3]; Scatteia et al., 13th AIAA/CIRA International Space Planes and Hypersonic Systems and Technologies Conference, May 2005, Capua, Italy, pp. 2055-2062, reference [4]). However, these publications mention nothing about LOX compatibility according to standard ASTM D2512 for the suggested materials.

Moreover, it has also been suggested that liquid oxygen tanks without liners could be made using firstly composite materials with a graphite-reinforced epoxy matrix (Robinson et al., 42th AIAA/ASME/ASCE/AHS/ASC Structures, Structural Dynamics and Materials Conference and Exhibit, April 2001, Seattle, USA, pp. 285-295, reference [5]), and secondly composite materials with a carbon fibre-reinforced epoxy or cyanate ester matrix (Scatteia et al., references [3] and [4] mentioned above). However, once again, LOX compatibility according to standard ASTM D2512 for these materials has not been demonstrated.

Furthermore, compatibility with liquid oxygen according to standard ASTM D2512 is not the only criterion that has to be satisfied by a material before it can be used for manufacturing of liquid oxygen tanks for use in space launchers. As mentioned above, the material also needs to be leak tight to liquid oxygen and only slightly permeable to gases and particularly helium.

It should also have the lowest possible density such that objectives to reduce the weight of space launchers can be achieved, and if the material is to perform a structural function, that it should have inherent mechanical properties capable of fulfilling these functions.

Finally, it is desirable that it should be relatively inexpensive, easy to manufacture and that it could be transformed without any particular H&S risk, particularly into large volume parts (in other words parts that can contain 3 to 5 m³ of liquid oxygen), making use of conventional techniques in the field of plastics technology such as spin casting.

The purpose of the invention is a composite material that satisfies all these criteria and therefore is suitable for use for containment of liquid oxygen, particularly in a space launcher.

Obviously, since this material satisfies the very strict constraints specific to the containment of liquid oxygen in space applications, it is also suitable for containing liquid oxygen in less restrictive applications and for containing cryogenic liquids other than liquid oxygen.

### Presentation of the Invention

Therefore, the first purpose of the invention is the use of a composite material for manufacturing a device for containment of a cryogenic liquid, in which the composite material is obtained from a composition comprising, in percentages by weight relative to the total weight of the composition:
from 60% to 90% of a polyamide chosen from polyamides 6, 6.6 and 6/6.6 and mixtures thereof;
from 10% to 30% of a primary synthetic graphite in the form of particles;

and
from 0% to 10% of an anti-oxidant.

In the above and in the following, a <<primary synthetic graphite>>, means a graphite obtained synthetically but that is not subject to any particular treatment at the end of this synthesis, unlike an oxidised synthetic graphite that is obtained by adding a primary synthetic graphite into a highly oxidising solution (typically composed of potassium permanganate and sulphuric acid), which has the effect of making it more polar than the primary synthetic graphite, or an exfoliated synthetic graphite that is obtained by applying a heat treatment to an oxidised synthetic graphite which has the effect of making its apparent density lower than that of the primary synthetic graphite.

Primary synthetic graphite particles are obtained particularly from the TIMCAL Company.

Furthermore, in the above and in the following, the term <<anti-oxidant>> means any compound capable of inhibiting oxidation of a polyamide regardless firstly of the origin of this oxidation (heat treatment in contact with air, action of UV light, etc.) and secondly the mechanism for this inhibition (radicalar inhibition, inhibition of hydroperoxydes, etc.).

According to the invention, the polyamide is preferably a polyamide 6 like that marketed by the SOLVAY Company reference Technyl™ S27 BL, this type of polyamide being particularly suitable for transformation of the composite material by spin casting.

Furthermore, the primary synthetic graphite is preferably a primary synthetic graphite with at least one of the following characteristics:

(1) 50% by volume of the particles (d50) of this graphite have a size (in this case <<size>> means <<largest dimension>>) equal to at most 25 μm and 90% by volume of particles (d90) have a size equal to at most 65 μm;

(2) a specific area (as determined by the BET method) between 5 and 8 m²/g and even better, between 6 and 7 m²/g;

(3) a carbon content by weight equal to at least 99.9%.

Advantageously, the primary synthetic graphite has two of the above-mentioned characteristics (1), (2) and (3) and even better these three characteristics at the same time.

One such graphite is for example graphite marketed by the TIMCAL Company with reference Timrex™ KS75 that has a d90 between 48 and 65 urn, a specific BET area of 6.5 m²/g and a carbon content by weight of more than 99.9%.

According to the invention, the composite material preferably comprises an anti-oxidant, which means that the weight percentage of this agent in the composition is different from 0%.

The antioxidant may be chosen from all the compounds for which use has been proposed to prevent or retard oxidation of a polyamide. In this respect, the reader can refer to the monograph <<Stabilisation des Plastiques: Principes Généraux>>, in Techniques de l'Ingénieur, Traité Plastiques et Composites, AM 3 232, pp. 1-14, reference [6].

However, for the purposes of the invention, it is preferred that the antioxidant should be a thermal stabiliser, i.e. a compound capable of inhibiting oxidation of a polyamide at high temperature. Indeed, not only does the presence of a thermal stabiliser in the composition stabilise this composition during manufacturing of the composite material, for example by extrusion, it also stabilises the composite material itself during its later transformation if this transformation is done using a technique including a heat treatment of the composite material, which is the case particularly for transformation by spin casting.

Examples of thermal stabilisers that might be suitable include inorganic iodides such as copper iodide and potassium iodide, phenolic compounds such as those marketed by the BASF Company under references Irganox™ 245, Irganox™ 1010, Irganox™ 1098 and Irganox™ MD 1024, or that marketed by the ADDIVANT Company under reference Lowinox™ 44B25, phosphites like that marketed by the BASF Company under reference Irgafox™ 168, and amine type stabilisers like those marketed by the CHEMTURA Company under reference Naugard™ 445 and the BASF Company under reference Tinuvin™ 770.

Obviously, a mixture of two or more of these thermal stabilisers could be envisaged.

According to the invention, the thermal stabiliser is preferably a phenolic compound and even more preferably a sterically hindered phenolic compound such as Irganox™ 1098.

Furthermore, this phenolic compound is advantageously present in the composition with a weight percentage of 5±2% relative to the total weight of material.

Depending on the use for which the cryogenic liquid containment device is intended and/or the function that the composite material is intended to fulfil in this device (leak tightness function, structural function, etc.), the composition may also comprise one or several additives such as plasticizers, colouring agents and/or pigments, antistatic fillers, impact modifiers, fire retardants, etc.

According to one particularly preferred arrangement of the invention, the composition comprises, in percentages by weight relative to the total weight of the composition:
75±2% of a polyamide 6;
20±2% of the primary synthetic graphite; and
5±2% of a phenolic compound as an anti-oxidant.

According to the invention, the composite material may consist of the composition alone, i.e. it comprises nothing other than the composition. In this case, the composite material may be obtained particularly by mixing the various constituents of the composition, for example by extrusion, and then reducing the resulting mixture to the state of particles, for example by micronisation.

As a variant, the composite material may also comprise reinforcement, in which case the composition is used to form a matrix containing this reinforcement. In this case, depending on the nature of the reinforcement, the composite material may be obtained particularly by extrusion (in which case reinforced pellets are obtained), by coextrusion (in which case plates composed of a stampable reinforced thermoplastic are obtained) or by electrostatic impregnation (using the material alone in powder form). The partly finished product obtained can be transformed into a final part making use of different techniques such as injection, compression, moulding and particularly spin casting or filament winding.

In general, for a transformation by spin casting, a composite material used in preference has a viscosity less than 4000 Pa·s at the spin casting temperature (namely, for example, about 240° C. in the case of a composite material based on the polyamide 6 Technyl™ S27 BL made by the SOLVAY Company, this viscosity for example being determined using an ARES rotary rheometer (RHEOMETRIC SCIENTIFIC Company) and at a rotation speed of 1 radian/second.

Different types of reinforcement may be used within the composite material. Thus, the reinforcement may be composed of quartz fibers, carbon fibers, graphite fibers, silica fibers, metal fibers such as steel fibers, aluminium fibers or boron fibers, organic fibers such as aramide fibers, polyethylene fibers, polyester fibers or poly(p-phenylene benzobisoxazole) fibers (better known as PBO), or mixtures of these fibers.

Moreover, the reinforcement may be in the form of cut threads, ground fibers, continuous filament mats, cut filament mats, rovings, fabrics, knits, felt, etc, or in the form of complexes made by association of different types of plane materials, depending on the nature of the fibers contained in it.

Another purpose of the invention is a device for containment of a cryogenic liquid which comprises at least one layer made of a composite material as previously defined.

According to the invention, the containment device is preferably a multilayer device in which one layer is intended to be in contact with the cryogenic liquid, in which case this layer is made of a composite material which is constituted by the composition alone, i.e. which comprises nothing other than this composition.

Such a layer corresponds, for example, to the liner of a liquid oxygen tank for a space launcher.

Advantageously, the containment device also comprises at least one layer made of a composite material comprising reinforcement.

Such a layer corresponds, for example, to a layer which is intended to perform a structural function in a liquid oxygen tank for a space launcher.

Preferably, the containment device is a cryogenic tank and particularly a liquid oxygen tank, particularly for a space launcher.

Other characteristics and advantages of the invention will become clear after reading the following detailed description related to an example embodiment of a composite material according to the invention and a demonstration of its properties.

Obviously, this example is only given to illustrate the purpose of the invention and in no way forms a limitation of this purpose.

### DETAILED PRESENTATION OF PARTICULAR EMBODIMENTS

A first composite material according to the invention—(material 1 in the following description)—is prepared by mixing:
80% by weight of a polyamide 6 (Technyl™ S27 BL—made by the SOLVAY Company); and
20% by weight of primary synthetic graphite marketed by the TIMCAL Company under reference Timrex™ KS75.

The mixture is made by twin-screw extrusion (screw profile L/D=48) at a temperature of 240° C. and with a screw rotation speed of 300 rpm.

The extrudate obtained is cold micronised to obtain a powder in which an average diameter by volume of the particles is a few hundred microns.

The material 1 thus prepared is subjected to tests in order to evaluate its LOX compatibility, its permeability to helium, its density, its tensile Young's modulus at T=123 K, its ultimate tensile strain at T=123 K and its coefficient of thermal expansion at T<Tg.

The LOX compatibility is determined according to standard ASTM D2512 on samples obtained by injection of material 1 and in the form of disks with a diameter of 18±0.1 mm and a thickness of 1.65±0.05 mm.

Permeability to helium is determined by a helium permeation test performed using an instrument composed of two compartments separated by a 150 μm thick film of material 1, obtained by compression of a disk like as used to determine LOX compatibility. The surface of the film on which the permeation test is made is 3 cm². Before the test, the material is desorbed under a vacuum to make sure that pressure variations in the downstream compartment are lower than pressure variations due to diffusion of helium. A differential pressure (ΔP) of 3 bars is then applied between the two compartments and the increase in the pressure P in the downstream chamber is recorded as a function of time, using a pressure sensor (DATAMETRICS). The result obtained after a transient phase is a state of equilibrium in the pressure variation as a function of time, the gradient of which is used to calculate the coefficient of permeability to helium. The test is done at 20° C.

The density is determined by means of a helium pycnometer (Accupyc™ 1330—MICROMERITICS Company) using the following procedure: dry a sample of the material in a drying oven at 50° C. for 12 hours; cool the sample in a dryer; weigh the dry sample; calibrate and check the pycnometer according to the manufacturer's instructions; measure the density (at least 5 measurements) and record the density thus measured.

The tensile Young's modulus and the ultimate tensile strain at T=123 K are determined based on standards ISO 527-1 and ISO 527-2 (dealing with tests to determine the mechanical properties of plastics) and standard ISO 1874-2 (dealing with polyamides), using type 5A test pieces, obtained by injection of material 1 and with a thickness of 2 mm.

The coefficient of thermal expansion at T<Tg is determined on samples obtained by injection of material 1 and in the form of 6 mm diameter and 25 mm thick cylinders, using a thermomechanical analyser (TMA model 2940—TA INSTRUMENTS Company) and using the following operating parameters: rate of temperature increase 5° C./min; temperature range: from −150° C. to 130° C.; under nitrogen flushing; 6 mm diameter probe; 0.1 N load and 0.05 N preload.

The test results are given in table I below.

TABLE I

| | |
|---|---|
| LOX compatibility | 0 |
| (number of reactions on 20 impacts) | |
| Permeability to helium | 0.45 |
| (Barrer) | |
| Density | 1.23 |
| Tensile Young's modulus at T = 123K | 4.5 ± 0.2 |
| (GPa) | |
| Ultimate tensile strain at T = 123K | 4 ± 1 |
| (%) | |
| Coefficient of thermal expansion at T < Tg | 44.10⁻⁶ |
| (K⁻¹) | |

A second composite material according to the invention—material 2 below—is prepared using exactly the same protocol as described above for preparation of material 1 except that the mixture consists of 75% by weight of polyamide 6, 20% by weight of primary synthetic graphite and 5% by weight of a sterically hindered phenolic antioxidant (Irganox™ 1098—BASF Company).

Material 2 is also tested for LOX compatibility but on samples obtained by spin casting and in the form of hollow 25 cm cubes with an average wall thickness of 3 mm. The LOX compatibility of this material is exactly the same as that obtained for material 1 (no reaction on 20 impacts).

These results show that the LOX compatibility of the composite material according to the invention satisfies standard ASTM D 2512 (no reaction on 20 impacts), regardless of whether or not it contains an antioxidant.

The composite material according to the invention also has extremely low permeability to helium, so that it can be also considered to be impermeable or almost impermeable to liquid oxygen. Indeed, it is well known that the permeability of an element to helium is higher than the permeability of the same element to gaseous oxygen (since the volume of a molecule of oxygen in the gaseous state is larger than the volume of a molecule of helium), this permeability in principle being higher than the permeability of said element to liquid oxygen. It is also well known that the permeability of an element to permanent gases reduces when the temperature drops. Since the value of the permeability to helium given in table I was obtained at 20° C., therefore the permeability to helium (and consequently to liquid oxygen) of the composite material according to the invention will be even lower at cryogenic temperatures.

The composite material according to the invention also has extremely satisfactory mechanical properties.

Therefore, this material is an ideal material for manufacturing liquid oxygen tanks, particularly for space launchers.

### REFERENCES

[1] Kooij et al., Proceedings of the European Conference on Spacecraft Structures, Materials and Mechanical Testing, Nov. 29-Dec. 1, 2000, Noordwijk, Netherlands, pp. 187-192
[2] Baker et al., International Conference on Green Propellant for Space Propulsion, June 2001, Noordwijk, Netherlands, pp. 327-334
[3] Scatteia et al., Proceedings of the 54th International Astronautical Congress of the International Astronautical Federation, October 2003, Bremen, Germany, pp. 1630-1642
[4] Scatteia et al., 13th AIAA/CIRA International Space Planes and Hypersonic Systems and Technologies Conference, May 2005, Capua, Italy, pp. 2055-2062
[5] Robinson et al., 42th AIAA/ASME/ASCE/AHS/ASC Structures, Structural Dynamics and Materials Conference and Exhibit, April 2001, Seattle, USA, pp. 285-295
[6] <<Stabilisation des Plastiques: Principes Généraux>> (Stabilisation of Plastics: General principle), in Techniques de l'Ingénieur, Traité Plastiques et Composites, AM 3 232, pp. 1-14

What is claimed is:

1-15. (canceled)

16. A device for containment of a cryogenic liquid, comprising at least one layer of a composite material, in which the composite material is obtained from a composition comprising, in percentages by weight relative to the total weight of the composition:
from 60% to 90% of a polyamide 6, a polyamide 6.6, a polyamide 6/6.6, or a mixture thereof;
from 10% to 30% of particles of a primary synthetic graphite; and
from 0% to 10% of an anti-oxidant.

17. The device of claim 16, in which the polyamide is a polyamide 6.

18. The device of claim 16, in which the particles of the primary synthetic graphite have at least one of characteristics (1), (2) and (3):
(1) 50% by volume of the particles have a size equal to at most 25 μm and 90% by volume of the particles have a size equal to at most 65 μm;
(2) a specific area BET between 5 m²/g and 8 m²/g;
(3) a carbon content by weight equal to at least 99.9%.

19. The device of claim 18, in which the particles of the primary synthetic graphite have two of the characteristics (1), (2) and (3).

20. The device of claim 18, in which the particles of the primary synthetic graphite have the three characteristics (1), (2) and (3).

21. The device of claim 16, in which the percentage by weight of the anti-oxidant is higher than 0%.

22. The device of claim 21, in which the anti-oxidant is a thermal stabiliser.

23. The device of claim 22, in which the anti-oxidant is a phenolic compound.

24. The device of claim 23, in which the composition comprises a percentage by weight of 5±2% of the phenolic compound.

25. The device of claim 24, in which the composition comprises:
75±2% of a polyamide 6;
20±2% of the particles of the primary synthetic graphite; and
5±2% of the phenolic compound.

26. The device of claim 16, in which the composite material consists of the composition.

27. The device of claim 16, in which the composite material further comprises a reinforcement.

28. The device of claim 27, in which the reinforcement is quartz fibers, carbon fibers, graphite fibers, silica fibers, metal fibers, aramide fibers, polyethylene fibers, polyester fibers, poly(p-phenylene benzobisoxazole) fibers, or a mixture thereof.

29. The device of claim 16, which is a multilayer device in which the layer of the composite material is to be in contact with the cryogenic liquid and the composite material of the layer consists of the composition.

30. The device of claim 29, in which the multilayer device further comprises one or more layers of the composite material and the composite material of the layer(s) further comprises a reinforcement.

31. The device of claim 29, which is a cryogenic tank.

32. The device of claim 31, which is a liquid oxygen tank.

33. The device of claim 32, which is a liquid oxygen tank of a space launcher.
